(19) United States
(12) Patent Application Publication
(10) Pub. No.: US 2026/0205867 A1
(43) Pub. Date: Jul. 16, 2026

(54) DYNAMIC SPECTRUM MANAGEMENT USING SPECTRUM MANAGER

(71) Applicant: DISH Wireless L.L.C., Englewood, CO (US)

(72) Inventors: Dilip Tandekar, Herndon, VA (US); Premchand Chandran, Brambleton, VA (US)

(21) Appl. No.: 19/016,410

(22) Filed: Jan. 10, 2025

(51) Int. Cl. H04W 28/02; H04W 16/14

(52) U.S. Cl. CPC H04W 28/0268; H04W 16/14

(57) ABSTRACT

Technologies for dynamic spectrum management in a cellular network are described. One method include receiving a plurality of requests from one or more user equipment (UE); determining a quality of service (QoS) metric associated with a first request of the plurality of requests; retrieving a plurality of spectrum parameters associated with spectrum of the cellular network; determining one or more spectrum bands for the first request according to the QoS metric and the plurality of spectrum parameters; and allocating the one or more spectrum bands responding to the first request to a corresponding UE of the one or more UE.

### BACKGROUND

Cellular networks are highly complex. One type of cellular network is a fifth generation (5G) new radio (NR) cellular network. 5G NR cellular networks have the promise to provide higher throughput, lower latency, and higher availability compared with previous global wireless standards. However, various spectrum bands are not efficiently utilized in a 5G NR cellular network, which may compromise such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing dynamic spectrum management in a cellular network according to at least one embodiment.

FIG. 2 is a block diagram of a system including spectrum managers that implement dynamic spectrum management in a cellular network according to at least one embodiment.

FIG. 3 illustrates an example data flow for a spectrum manager that implements dynamic spectrum management in a cellular network according to at least one embodiment.

FIG. 4 is a flow diagram of an example method of implementing dynamic spectrum management in a cellular network according to at least one embodiment.

FIG. 5 is a block diagram of an example computer system in which embodiments of the present disclosure can operate.

### DETAILED DESCRIPTION

Technologies for dynamic spectrum management in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Spectrum bands for 5G NR cellular networks are used to provide interface or radio access technology for the communication within the cellular networks. Each spectrum band can cover a frequency range (e.g., n1, n2, etc.), and the cellular networks may use a great number of spectrum bands for various communications. However, the spectrum bands are not utilized efficiently (e.g., by multiple operators), and the user demand and network conditions are not considered in allocation of the spectrum bands.

Aspects and embodiments of the present disclosure address the above and other deficiencies by providing a system that implements dynamic spectrum management in a cellular network. Specifically, a component of the cellular network (e.g., spectrum manager) may be implemented into the cellular network or one or more of portions (e.g., one or more radio access networks (RANs)) in the cellular network. The component of the cellular network (e.g., spectrum manager) may retrieve information of the demand on spectrum and status of spectrum usage to dynamically allocate the spectrum bands to each request such that the spectrum of the cellular network can be used more efficiently.

Specifically, the component of the cellular network (e.g., spectrum manager) may receive requests from one or more user equipment (UE), and for each request, determine a quality of service (QoS) metric associated with the request. In some implementations, the QoS metric may include one or more of: a QoS identifier, a mean opinion score (MOS), a spectrum efficiency parameter, an energy efficiency parameter, a performance parameter, a traffic parameter, an interference parameter, or a prediction parameter, or a combination thereof. These QoS metrics as described in detail below can characterize the demand on the spectrum from each request (e.g., bandwidth requirement).

The component of the cellular network (e.g., spectrum manager) may retrieve the spectrum parameters associated with spectrum of the cellular network. In some implementations, the spectrum parameters may include one or more of: availability of spectrum bands, status of cell sites associated with spectrum, or an alarm associated with spectrum. These spectrum parameters as described in detail below can characterize the current status of the spectrum. As such, the component of the cellular network (e.g., spectrum manager) may determine one or more spectrum bands according to the QoS metric associated with the request and the spectrum parameters associated with the spectrum. The component of the cellular network (e.g., spectrum manager) may allocate the determined spectrum bands responding to the respective request.

In some implementations, the component of the cellular network (e.g., spectrum manager) may monitor the QoS metric and the spectrum parameters. The component of the cellular network (e.g., spectrum manager) may determine that any of the QoS metric and the spectrum parameters satisfies a respective threshold criterion (e.g., the QoS metric or a specific spectrum parameter described above reaches or exceeds (or not reach or exceed) a threshold value), which means that the change associated with the demand on the spectrum and/or the change associated with the current status of the spectrum requires a redetermination of the spectrum bands for efficient spectrum usage. The component of the cellular network (e.g., spectrum manager) may then redetermine the spectrum bands according to the QoS metric and the spectrum parameters and allocate the redetermined spectrum bands. As such, the component of the cellular network (e.g., spectrum manager) may serve the low bandwidth to low-bandwidth-demand UE and the high bandwidth to high-bandwidth-demand UE.

In some implementations, the component of the cellular network (e.g., spectrum manager) may communicate with the service management and orchestration (SMO) platform, which may manage network elements, where the network element is a manageable logical entity uniting one or more physical devices. In some implementations, the spectrum manager may communicate the information associated with the spectrum of the cellular network with the SMO platform such that the SMO platform can facilitate the spectrum manager to manage the spectrum at a global level.

Aspects and embodiments of the present disclosure can use spectrum manager for dynamic spectrum allocation in the cellular network, instead of the static spectrum allocation. Aspects and embodiments of the present disclosure can improve the efficiency in spectrum usage, provide enhanced load management and energy saving, and allow optimization of the network performance and failure prediction.

Aspects of the present disclosure can provide enhanced interference management by dynamically detecting and mitigating cross-channel interference, improving overall network quality and ensuring optimal spectrum utilization across multiple cells. Aspects of the present disclosure can provide enhanced private network spectrum management by managing spectrum in enterprise or private 5G networks where resources are dynamically allocated for specific use cases like internet of things (IoT), (augmented virtuality) AR/(virtual reality) VR, or mission-critical communications. Aspects of the present disclosure can provide enhanced load balancing across spectrum by dynamically balancing load across different frequency bands (e.g., low-, mid-, high-band) to ensure optimized usage and prevent congestion in any one part of the spectrum. Aspects of the present disclosure can provide enhanced traffic-aware spectrum allocation by dynamically adjusting spectrum allocation based on real-time traffic, prioritizing spectrum for critical services (e.g., ultra-reliable low latency communications (URLLC) in 5G) or high-density user areas. Aspects of the present disclosure can provide enhanced energy-efficient spectrum usage by optimizing spectrum allocation in a way that reduces power consumption by adjusting transmission power levels or switching off underused spectrum bands during low-traffic periods. Aspects of the present disclosure can provide enhanced spectrum aggregation by coordinating the aggregation of multiple spectrum bands for higher throughput to manage bands that are combined dynamically based on demand and conditions. Spectrum aggregation is a feature that enables the combination of multiple carriers in fragmented spectrum bands to increase peak user data rates and overall capacity of the network as well as to reduce the packet latency.

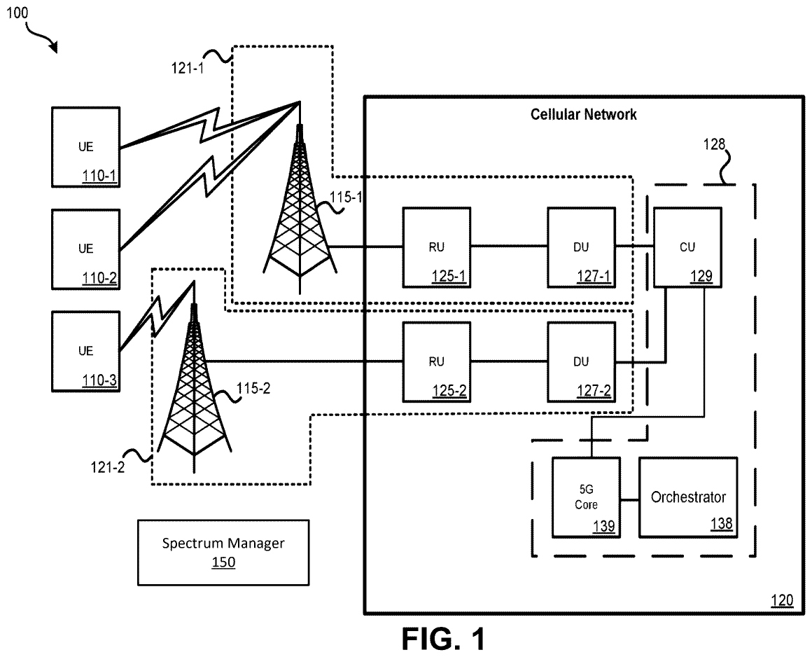

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection-and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

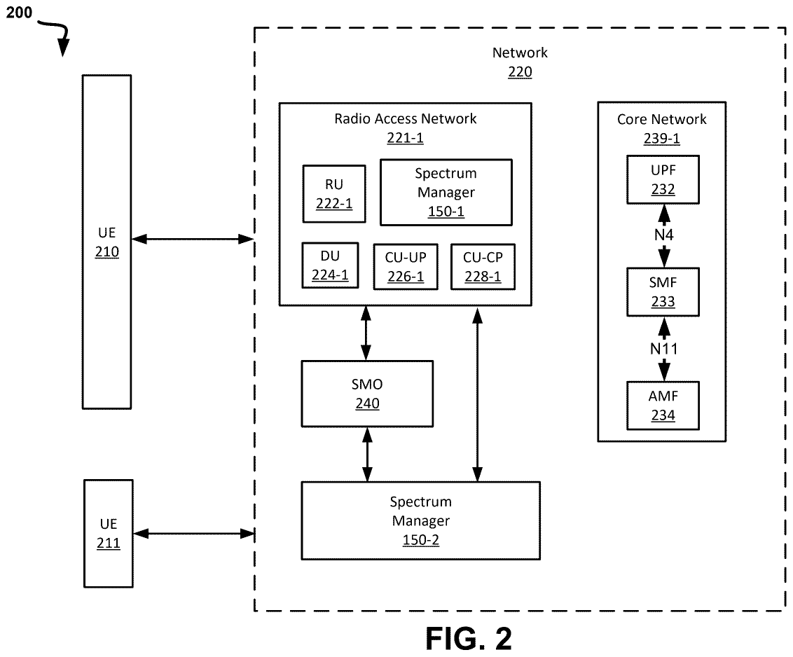

In some embodiments, the system 100 can include a spectrum manager 150 to implement dynamic spectrum management in a cellular network. Further details regarding the operations of the spectrum manager are described below with reference to FIGS. 2-5.

FIG. 2 is a block diagram of example spectrum managers according to at least one embodiment. Referring to FIG. 2, a network 220 includes one or more radio access network (RAN) 221-1, and one or more core network 239-1, according to at least one embodiment. The network 220 may include 4G network, 5G network, 6G network, etc. The network 220 connects user equipment (UE) 210 to the data network (not shown), and the data network can include the Internet, a local area network (LAN), a wide area network (WAN), a private data network, a wireless network, a wired network, or a combination of networks. The UE 210 can include an electronic device with wireless connectivity or cellular communication capability, such as a mobile phone or handheld computing device. In at least one example, the UE 210 can include a 5G smartphone or a 5G cellular device that connects to the RAN 221-1, via a wireless connection. The UE 210 can include one of a number of UEs not depicted that are in communication with the RAN 221-1. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221-1.

The RAN 221-1 includes a remote radio unit (RU) 222-1 for wirelessly communicating with UE 210. The remote radio unit (RU) 222-1 can include a radio unit (RU) and may include one or more radio transceivers for wirelessly communicating with UE 210. The remote radio unit (RU) 222-1 may include circuitry for converting signals sent to and from an antenna of a Base Station into digital signals for transmission over packet networks. In some implementations, the RAN 221-1 may correspond with a 5G radio Base Station that connects user equipment to the core network 239-1. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210.

The RAN 221-1 can include a new-generation radio access network (NG-RAN) that uses the 5G NR interface. In some embodiments, the distributed unit (DU) 224-1 and the centralized unit (CU) of the RAN 221-1 may be co-located with the RU 222-1. In other embodiments, the DU 224-1 and the RU 222-1 may be co-located at a cell site and the centralized unit (CU) may be located within a local data center (LDC). The DU 224-1 can include a logical node configured to provide functions for the radio link control (RLC) layer, the medium access control (MAC) layer, and the physical layer (PHY) layers. The centralized unit (CU) can be partitioned into a CU user plane portion (CU-UP) 226-1 and a CU control plane portion (CU-CP) 228-1. The CU-CP 228-1 may perform functions related to a control plane, such as connection setup, mobility, and security. The CU-UP 226-1 may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) 228-1 can include a logical node configured to provide functions of the control plane part of the RRC and PDCP. The centralized unit for the user plane(CU-UP) 226-1 can include a logical node configured to provide functions of the user plane part of the SDAP and PDCP. In some embodiments, the RAN 221-1 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221-1 may include a set of one or more remote radio units (RUs) that includes radio transceivers (or combinations of radio transmitters and receivers) for wirelessly communicating with UEs. The set of RUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RU).

In some cases, the UE 210 may be capable of transmitting signals to and receiving signals from one or more RUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239-1 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239-1 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) 234, the session management function (SMF) 233, and the user plane function (UPF) 232. The AMF 334 may interface with UE 210, act as a single-entry point for a UE connection, and perform mobility management, registration management, and connection management between data network and UE 210. The AMF 334 may interface with the SMF 333 to track user sessions. The AMF 334 may interface with a network slice selection function (NSSF) 338 to select network slice instances for user equipment. When user equipment is leaving a first coverage area and entering a second coverage area, the AMF 334 may be responsible for coordinating the handoff between the coverage areas whether the coverage areas are associated with the same radio access network or different radio access networks. The SMF 333 may perform session management, user plane selection, and Internet Protocol (IP) address allocation. After the Access Gateway Function (AGF) authenticates the subscriber and establishes a protocol data unit (PDU) session, the SMF 333 may select the UPF for the subscriber.

The UPF 232 may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF 232 may serve as an ingress and egress point for user plane traffic and provide anchored mobility support for user equipment. The UPF 232 may be implemented as a software process or application running within a virtualized infrastructure or a cloud-based compute and storage infrastructure.

The UPF 232 may transfer downlink data received from the data network to the UE 210, via the RAN 221-1 and/or transfer uplink data received from the UE 210 to the data network via the RAN 221-1. An uplink can include a radio link though which UE 210 transmits data and/or control signals to the RAN 221-1. A downlink can include a radio link through which the RAN 221-1 transmits data and/or control signals to the UE 210.

Uplink packets arriving from the RAN 221-1 may use a general packet radio service (GPRS) tunneling protocol (or GTP) to reach the UPF 232. The GPRS tunneling protocol for the user plane may support multiplexing of traffic from different PDU sessions by tunneling user data over the interface N3 between the RAN 221-1 and the UPF 232. The UPF 232 may remove the packet headers belonging to the GTP tunnel before forwarding the user plane packets towards the data network. As the UPF 232 may provide connectivity towards other data networks in addition to the data network, the UPF 232 ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF 232 may keep a record of the mapping between the GTP tunnel, the PDU session, and the DNN for the data network to which the user plane packets are directed.

Downlink packets arriving from the data network are mapped onto a specific quality of service (QoS) flow belonging to a specific PDU session before forwarded towards the appropriate RAN 221-1. A QoS flow may correspond with a stream of data packets that have equal QoS. The PDU session may utilize one or more QoS flows to exchange traffic (e.g., data and voice traffic) between the UE 210 and the data network. The one or more QoS flows can include the finest granularity of QoS differentiation within the PDU session. The PDU session may belong to a network slice instance through the network 220. To establish user plane connectivity from the UE 210 to the data network, the AMF 234 that supports the network slice instance may be selected and a PDU session via the network slice instance may be established. In some cases, the PDU session may be of type IPv4 or IPv6 for transporting IP packets. The RAN 221-1 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) (not shown) for providing application services. Application-level session information may be exchanged between the AF and PCF (e.g., bandwidth requirements for QoS). In some cases, when the UE 210 requests access to resources, such as establishing a PDU session or a QoS flow, the PCF may dynamically decide if the UE 210 should grant the requested access based on a location of the UE 210.

The network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a network, such as an instantiation of the network 220. In some cases, the network 220 may support customized policy configuration and enforcement between network slices per service level agreements (SLAs) within the radio access network (RAN) 221-1. User equipment, such as UE 210, may connect to multiple network slices at the same time (e.g., eight different network slices). In some cases, the network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

In some implementations, RAN 221-1 may include the spectrum manager 150-1 to implement dynamic spectrum management in RAN 221-1. In some implementations, network 220 may include the spectrum manager 150-2 to implement dynamic spectrum management in network 220 or in part of network 220. For example, the part of network 220 may refer to a portion of network 220 or a region of the network 220. In some implementations, one or more spectrum managers may be included in other part(s) of the network 220. In some implementations, each spectrum manager described in FIG. 2 may be the same as the spectrum manager 150. In some implementations, one or more spectrum managers described in FIG. 2 may work together to fulfill the functions provided by the spectrum manager 150.

In some implementations, the spectrum manager 150-1 may receive one or more requests from UE 210, wherein each request may be associated with a demand on the spectrum bands. In some implementations, the spectrum manager 150-1 may receive multiple requests from multiple UE such as UE 210, UE 211. The spectrum manager 150-1 will respond to each of such requests by providing the respective spectrum bands as described in detail below. The spectrum manager 150-1 will provide the spectrum bands in a dynamic manner for each request, and thus providing a global management of the spectrum allocation and utilization in the network 220. To simplify the description, a single request will be used for illustration, and the multiple requests in a dynamic manner are applicable according to the aspects of the present disclosure.

In some implementations, upon receiving a request from UE 210, the spectrum manager 150-1 may determine a quality of service (QoS) metric associated with the request. The QoS metric may comprise at least one of: a QoS identifier, a mean opinion score (MOS), a spectrum efficiency parameter, an energy efficiency parameter, a network performance parameter, a traffic parameter, an interference parameter, a prediction parameter, etc.

The quality of service (QoS) identifier refers to an indicator that represents the level of QoS. QoS is applied for each data stream all the way from the data network through every core network sitting on the data path to the US 210. The QoS flow is a logical pipeline defined for core network flow (more specifically for the data flow between the RAN 221-1 and core network 239-1). The QoS identifier is one of the parameters of the QoS flow and may include parameters specifying one or more of: resource type (guaranteed bit rate (GBR), non-GBR, or delay critical GBR), default priority level, packet delay budget, packet error rate, default maximum data burst volume, default averaging window, etc.

The mean opinion score (MOS) refers to a subjective metric that is obtained by having a group of customer rate the quality of audio samples. MOS is used to assess the quality of voice over NR (VoNR) services. VoNR means voice services carried end-to-end by 5G NR, 5G Core, and IMS. The overall level of audio and visual performance experienced during these voice services may be affected by the factors such as call clarity, signal strength, delay, echo, and other audio and visual distortions that can impact the user experience.

The spectrum efficiency parameter refers to the performance parameter that measures the amount of data that can be transmitted per unit of frequency bandwidth. The spectrum efficiency parameter may depend on various factors such as distance, propagation, channel impairments, interference, and modulation and coding parameters. For example, the spectrum efficiency parameter may include a link spectral efficiency parameter measured in bit/s/Hz, which is a net bit rate or maximum throughout divided by the bandwidths in Herts of a communication channel or a data link. As another example, the spectrum efficiency parameter may include a spectral efficiency measured in bit/symbol, which is equivalent to bits per channel use, implying that the net bit rate is divided by the symbol rate (modulation rate) or line code pulse rate. As yet another example, the spectrum efficiency parameter may include the average spectral efficiency (e.g., indoor hotspot—downlink 9/uplink 6.75, dense urban—downlink 7.8/uplink 5.4, rural—downlink 3.3/uplink 1.6), or the peak spectral efficiency (e.g., downlink—30 bits/sec/Hz, uplink—15 bits/sec/Hz).

The energy efficiency parameter refers to the ratio of useful outputs to energy inputs for a system. For example, the energy efficiency parameter may include the ratio of data transmission outputs to energy inputs for a system (such as efficient data transmission, low energy consumption) (e.g., 90% reduction in energy usage).

The network performance parameter refers to a measurement of the amount, the type, or the categories of network resources consumed. The network performance parameter may include peak data rates (e.g., downlink—20 gbps, uplink—10 gbps), data rate experienced by user (e.g., downlink—100 mbps, uplink—50 mbps), area traffic capacity (e.g., downlink—10 Mbits/sec/m² in indoor hotspots), latency (user plane) (e.g., 4 ms for enhanced mobile broadband (eMBB), 1 ms for ultra-reliable low latency communications (URLLC)), connection density (e.g., 1 million /vices/ km²), reliability (e.g., 1 packet loss out of 100 million packets), mobility (e.g., dense urban—up to 30 kmph, rural—up to 500 kmph), mobility interruption time (e.g., 0 ms), system bandwidth (e.g., at least 100 MHz, up to 1 GHz for operation in high-frequency bands above 6 GHz). In at least one embodiment, the network resources include a dedicated transport resource in a backhaul link or a fronthaul link, a dedicated RF resource instance, customer RAN data, a transport slice pipeline, secure signaling session data, a RU, a RAN resource, or another service in the cellular network.

The traffic parameter refers to the amount of data moving across the network (e.g., interfaces) at a given time point (e.g., real-time). The traffic parameter may depend on various interfaces (e.g., interface N4 between UPF 232 and SMF 233, interface N11 between AMF 234 and SMF 233, traffic in interface N3 between UPF 232 and RAN 221-1, traffic in interface N6 between UPF 232 and a data network, etc.), the type of traffic such as the type of data traffic or voice traffic, etc. For example, the voice traffic may use less physical resource blocks (due to less data volume and processing requirement) than the data traffic. The latency requirement for the voice traffic and the data traffic may be different, for example, the data traffic may require a closer proximity in the data center of the cellular network with respect to the user equipment than that of the voice traffic. The time requirement for the voice traffic and the data traffic may be different, for example, the voice traffic needs to be handled immediately when it happens, whereas the data traffic may not need to be handled immediately and can be delivered in a delayed mode.

The interference parameter refers to the level of undesired signal impacting the desired signal. The interference parameter may include at least one of: uplink block error rate (BLER) associated with a signal, or uplink bit error rate (BER) associated with a signal. BLER is the ratio of the number of transmission blocks received in error to the total number of blocks transmitted over a certain number of frames. BLER may reflect on the RF channel conditions and the level of interference. For a given modulation depth, the cleaner the radio channel or higher the SNR, the less likely the transport block being received in error. That indicates lower the possibility of error due to interference, i.e., a lower BLER. For a given modulation depth, the noisy the radio channel or lower the SNR, the more likely the transport block being received in error. That indicates higher the possibility of error due to interference, i.e., a higher BLER. Similarly, BER is the ratio of the number of bits received in error to the total number of bits transmitted over a certain number of frames. The interference parameters may include at least one of: uplink received signal strength indicator (RSSI), or uplink signal-to-interference-plus-noise ratio (SINR). RSSI and SINR may be measured in uplink primary resource block (PRB) granularity (per uplink PRB for the involved unlink resource allocation). RSSI is a relative index used to measure the relative quality of a received signal. SINR measures the strength of the wanted signal compared to the unwanted interference and noise. SINR may be a ration of signal power to noise and inference power. The interference parameters may include one or more of: the number of times of retransmission of a signal, the number of uplink primary resource block (PRB) allocated, used, and/or unused within a specific frequency domain and time domain, the power adjustment value, etc.

The prediction parameter may include a traffic prediction parameter that reflects a prediction of the traffic, a load demand prediction parameter that reflects a prediction of the load demand, a network performance (including a failure) prediction parameter that reflects a prediction of the performance or failure of a network resource. In some implementations, the prediction parameter may be associated with a user service requirement specified in the request, and the user service requirement may include a type of user service agreement in the user's subscription, load demand of a user service, etc. The type of user service agreement in the user's subscription may include a standard user service agreement, a premium user service agreement, or other user service agreement. For example, the standard user service agreement may have less priority in request handling than a premium user service agreement. The load demand of the user service may include a prediction of data size at a specific time point, for example, based on historical data of the user service, and the user service may be based on type of services, such as static or dynamic, that network is handling. In some embodiments, the prediction parameter can be provided by one or more machine learning models, which can be trained on a number of datasets that may include historical data and the corresponding predictions.

In some implementations, the spectrum manager 150-1 may retrieve information of parameters associated with spectrum (“spectrum parameters”) in the network 220. The spectrum parameters may characterize at least one of: the availability of spectrum bands, the status of cell sites associated with spectrum, or the alarm associated with spectrum.

The spectrum parameters characterizing availability of spectrum bands may indicate the available spectrum bands, the in-use spectrum bands, and the failed spectrum bands. The spectrum parameters characterizing the status of cell sites associated with spectrum may indicate the status of RU, including the data transaction handled by RU, an available capacity of RU (i.e., the available maximum amount of data that a radio transceiver can transmit or receive within a specific time frame), an available bandwidth of RU (e.g., each RU may provide different spectrum bands), or power consumption of RU. The spectrum parameters characterizing the alarm associated with spectrum may indicate the spectrum bands in an imminent failure condition.

In some implementations, the spectrum manager 150-1 may determine one or more spectrum bands for each request according to the QoS metric and the plurality of spectrum parameters. For example, a predetermined data structure may include a set of records, where each record provides a QoS metric and the corresponding spectrum parameters. In some implementations, the spectrum manager 150-1 may compare the determined (or monitored) QoS metric with the QoS metrics in the data structure to find the matched QoS metric in the data structure. In some implementations, the spectrum manager 150-1 may identify the corresponding spectrum parameters based on the matched QoS metric, and compare the identified spectrum parameters with the retrieved spectrum parameters to find matched spectrum parameters. The matched spectrum parameters can be used to identify one or more spectrum bands.

In some implementations, the spectrum manager 150-1 may monitor the QoS metric and determine whether the QoS metric satisfies a threshold criterion. For example, the threshold criterion may comprise a threshold value that is a minimum value that the QoS metric needs to meet. Responding to determining that the QoS metrics is larger than or equal to the threshold value, the spectrum manager 150-1 may determine that QoS metric satisfies the threshold criterion, and then redetermine the one or more spectrum bands for the request according to the QoS metric and the plurality of spectrum parameters. As such, the spectrum manager 150-1 may provide the spectrum bands dynamically along with the change of the QoS metric.

In some implementations, the spectrum manager 150-1 may monitor the plurality of spectrum parameters and determine whether at least one of the spectrum parameters satisfies a threshold criterion. For example, the threshold criterion may comprise a threshold value that is a minimum value that that spectrum parameter needs to meet. Responding to determining that the spectrum parameter is larger than or equal to the threshold value, the spectrum manager 150-1 may determine that at least one spectrum parameter of the plurality of spectrum parameters satisfies a threshold criterion, and then redetermine the one or more spectrum bands for the request according to the QoS metric and the plurality of spectrum parameters. As such, the spectrum manager 150-1 may provide the spectrum bands dynamically along with the change of the plurality of spectrum parameters.

In some implementations, the spectrum manager 150-2 may perform the operations similar to the spectrum manager 150-1 described above, except that the region served by the spectrum manager 150-2 is different from the RAN 221-1. In some implementations, the spectrum manager 150-2 may communicate with the service management and orchestration (SMO) platform 240. The SMO platform 240 may manage network elements, where the network element is a manageable logical entity uniting one or more physical devices. In some implementations, the spectrum manager 150-2 may communicate the information associated with the spectrum of the network 220 with the SMO platform 240 such that the SMO platform 240 can facilitate the spectrum manager 150 to manage the spectrum at a global level. In some implementations, the spectrum manager 150-2 may allocate the spectrum bands via the SMO platform 240.

In some implementations, the spectrum manager 150-1, 150-2 may allocate the spectrum bands determined above responsive to the respective request. For example, the spectrum manager 150-1, 150-2 may allocate the spectrum bands nX and nY to the first UE responding to the first request received from the first UE, and may allocate the spectrum band nZ to the second UE responding to the second request received from the second UE. In some implementations, allocating the spectrum bands may involve turning off a specific spectrum band (e.g., turning off the carrier), turning on a specific spectrum band (e.g., turning on the carrier), or switching energy mode provided to a specific spectrum band.

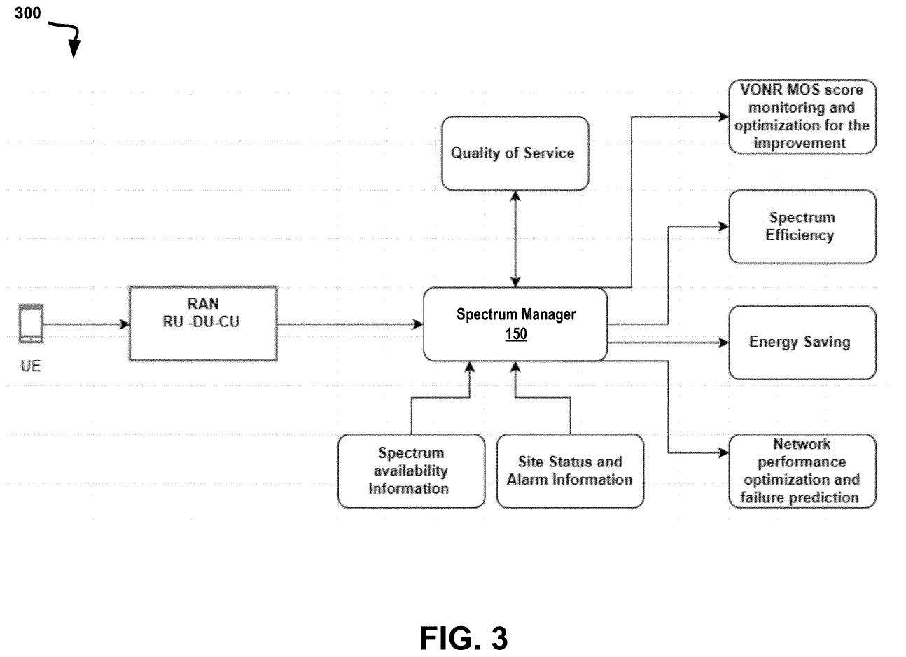

FIG. 3 illustrates an example data flow through a spectrum manager that implements dynamic spectrum management in a cellular network. In some implementations, the system 300 may include UE, RAN including RU, DU, CU, and the spectrum manager 150. Referring to FIG. 3, UE may send a request to RAN, where the request includes a demand on the spectrum bands. The RAN may relay the request to the spectrum manager 150. The spectrum manager 150 may determine and/or monitor the QoS metric associated with the request. The spectrum manager 150 may retrieve and/or monitor the spectrum parameters, including the information regarding the availability of spectrum, the status of cell sits, and the alarms described above. The spectrum manager 150 may determine one or more spectrum bands for the request according to the QoS metric and the spectrum parameters. The spectrum manager 150 may provide the determined spectrum bands responding to the request. The resulting performance of using the spectrum bands for the request, such as MOS, spectrum efficiency parameter, energy efficiency parameter, network performance parameter, prediction parameter, may be further monitored and reflected in the QoS metric described above. As such, the spectrum manager 150 may dynamically optimize the allocation and utilization of the spectrum bands in the system 300.

In some implementations, a system (e.g., system 100 in FIG. 1, or system 200 in FIG. 2) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a spectrum manager (e.g., the spectrum manager of FIGS. 1-3).

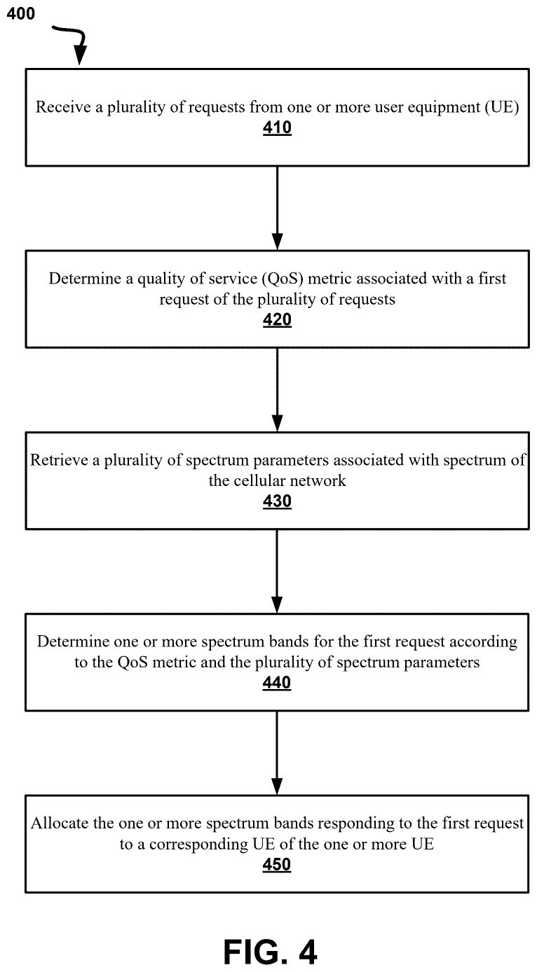

FIG. 4 is a flow diagram of a method 400 of dynamic spectrum management in a cellular network according to at least one embodiment. The method 400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 400 is performed by the system 100 of FIG. 1. In one embodiment, the method 400 is performed by the spectrum manager of FIGS. 1-3.

Referring to FIG. 4, at operation 410, the processing logic may receive a plurality of requests from one or more user equipment (UE) (e.g., UE 210, 211). In some implementations, each request of the plurality of the requests is associated with a demand on spectrum of the cellular network.

At operation 420, the processing logic may determine a quality of service (QoS) metric associated with a first request of the plurality of requests. In some implementations, the QoS metric comprises at least one of: a QoS identifier, a mean opinion score (MOS), a spectrum efficiency parameter, an energy efficiency parameter, a performance parameter, a traffic parameter, an interference parameter, or a prediction parameter.

At operation 430, the processing logic may retrieve a plurality of spectrum parameters associated with spectrum of the cellular network. In some implementations, the plurality of spectrum parameters comprise at least one of: availability of spectrum bands, status of cell sites associated with spectrum, or an alarm associated with spectrum.

At operation 440, the processing logic may determine one or more spectrum bands for the first request according to the QoS metric and the plurality of spectrum parameters. In some implementations, the processing logic may monitor the QoS metric, determine that QoS metric satisfies a threshold criterion, and redetermine the one or more spectrum bands for the first request according to the QoS metric and the plurality of spectrum parameters. In some implementations, the processing logic may monitor the plurality of spectrum parameters, determine that at least one spectrum parameter of the plurality of spectrum parameters satisfies a threshold criterion, and redetermine the one or more spectrum bands for the first request according to the QoS metric and the plurality of spectrum parameters.

At operation 450, the processing logic may allocate the one or more spectrum bands responding to the first request to a corresponding UE of the one or more UE. In some implementations, the processing logic may determine a respective quality of service (QoS) metric associated with each request of the plurality of requests, determine one or more respective spectrum bands for each request according to the respective QoS metric and the plurality of spectrum parameters, and allocate the one or more respective spectrum bands responding to each request to a corresponding UE of the one or more UE. In some implementations, allocating the one or more spectrum bands responding to the first request to a corresponding UE of the one or more UE is performed via a service management and orchestration platform (e.g., SMO 240).

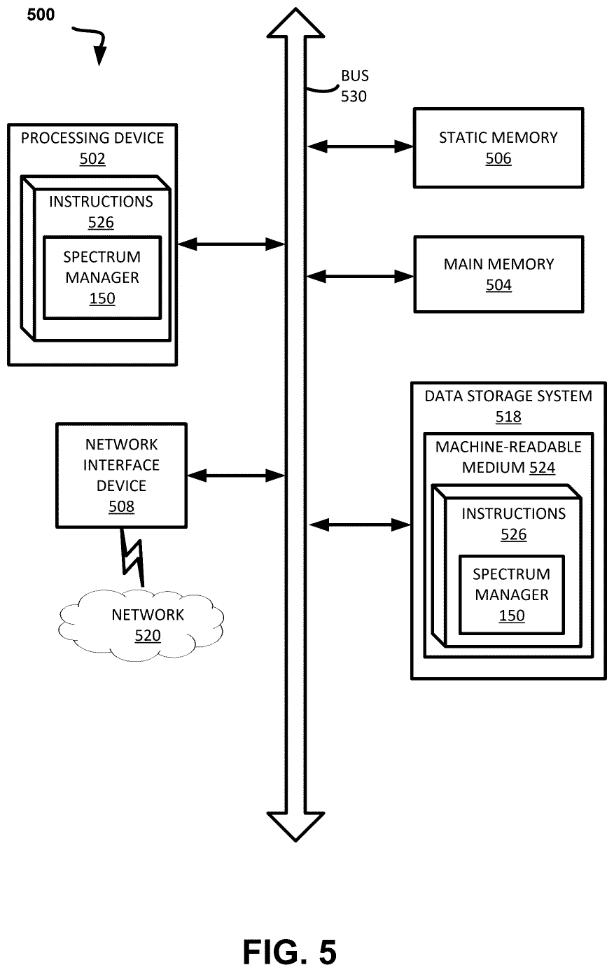

FIG. 5 illustrates an example machine of a computer system 500 within which a set of instructions, for causing the machine to perform any one or more of the methodologies discussed herein, can be executed. In some embodiments, the computer system 500 can be used to perform the operations of a controller (e.g., to execute an operating system to perform operations corresponding to the spectrum manager 150 of FIGS. 1-3). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520. The network 520 may correspond to the cellular network 120 of FIG. 1, the network 220 of FIG. 2, or the system 300 of FIG. 3.

The data storage system 518 can include a machine-readable storage medium 524 (also known as a computer-readable medium or a non-transitory computer-readable storage medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. In one embodiment, the processing device 502, the network interface 508, and the network 520 can correspond to the system 100 of FIG. 1, the system 200 of FIG. 2, or the system 300 of FIG. 3.

In one embodiment, the instructions 526 include instructions to implement functionality corresponding to the spectrum manager 150 of FIGS. 1-3. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of dynamic spectrum management in a cellular network, the method comprising:
receiving a plurality of requests from one or more user equipment (UE);
determining a quality of service (QoS) metric associated with a first request of the plurality of requests;
retrieving a plurality of spectrum parameters associated with spectrum of the cellular network;
determining one or more spectrum bands for the first request according to the QoS metric and the plurality of spectrum parameters; and
allocating the one or more spectrum bands responding to the first request to a corresponding UE of the one or more UE.

2. The method of claim 1, wherein the QoS metric comprises at least one of: a QoS identifier, a mean opinion score (MOS), a spectrum efficiency parameter, an energy efficiency parameter, a performance parameter, a traffic parameter, an interference parameter, or a prediction parameter.

3. The method of claim 1, wherein the plurality of spectrum parameters comprise at least one of: availability of spectrum bands, status of cell sites associated with spectrum, or an alarm associated with spectrum.

4. The method of claim 1, further comprising:
monitoring the QoS metric;
determining that QoS metric satisfies a threshold criterion; and
redetermining the one or more spectrum bands for the first request according to the QoS metric and the plurality of spectrum parameters.

5. The method of claim 1, further comprising:
monitoring the plurality of spectrum parameters;
determining that at least one spectrum parameter of the plurality of spectrum parameters satisfies a threshold criterion; and
redetermining the one or more spectrum bands for the first request according to the QoS metric and the plurality of spectrum parameters.

6. The method of claim 1, further comprising:
determining a respective quality of service (QoS) metric associated with each request of the plurality of requests;
determining one or more respective spectrum bands for each request according to the respective QoS metric and the plurality of spectrum parameters; and
allocating the one or more respective spectrum bands responding to each request to a corresponding UE of the one or more UE.

7. The method of claim 1, wherein allocating the one or more spectrum bands responding to the first request to a corresponding UE of the one or more UE is performed via a service management and orchestration platform.

8. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
receiving a plurality of requests from one or more user equipment (UE);
determining a quality of service (QoS) metric associated with a first request of the plurality of requests;
retrieving a plurality of spectrum parameters associated with spectrum of the cellular network;
determining one or more spectrum bands for the first request according to the QoS metric and the plurality of spectrum parameters; and
allocating the one or more spectrum bands responding to the first request to a corresponding UE of the one or more UE.

9. The computing system of claim 8, wherein the QoS metric comprises at least one of: a QoS identifier, a mean opinion score (MOS), a spectrum efficiency parameter, an energy efficiency parameter, a performance parameter, a traffic parameter, an interference parameter, or a prediction parameter.

10. The computing system of claim 8, wherein the plurality of spectrum parameters comprise at least one of: availability of spectrum bands, status of cell sites associated with spectrum, or an alarm associated with spectrum.

11. The computing system of claim 8, wherein the operations further comprise:
monitoring the QoS metric;
determining that QoS metric satisfies a threshold criterion; and
redetermining the one or more spectrum bands for the first request according to the QoS metric and the plurality of spectrum parameters.

12. The computing system of claim 8, wherein the operations further comprise:
monitoring the plurality of spectrum parameters;
determining that at least one spectrum parameter of the plurality of spectrum parameters satisfies a threshold criterion; and
redetermining the one or more spectrum bands for the first request according to the QoS metric and the plurality of spectrum parameters.

13. The computing system of claim 8, wherein the operations further comprise:
determining a respective quality of service (QoS) metric associated with each request of the plurality of requests;
determining one or more respective spectrum bands for each request according to the respective QoS metric and the plurality of spectrum parameters; and
allocating the one or more respective spectrum bands responding to each request to a corresponding UE of the one or more UE.

14. The computing system of claim 8, wherein allocating the one or more spectrum bands responding to the first request to a corresponding UE of the one or more UE is performed via a service management and orchestration platform.

15. One or more non-transitory, computer-readable storage media having computer-readable instructions thereon which, when executed by one or more processing devices, cause the one or more processing devices to perform operations comprising:
receiving a plurality of requests from one or more user equipment (UE);
determining a quality of service (QoS) metric associated with a first request of the plurality of requests;
retrieving a plurality of spectrum parameters associated with spectrum of a cellular network;
determining one or more spectrum bands for the first request according to the QoS metric and the plurality of spectrum parameters; and
allocating the one or more spectrum bands responding to the first request to a corresponding UE of the one or more UE.

16. The one or more non-transitory, computer-readable storage media of claim 15, wherein the QoS metric comprises at least one of: a QoS identifier, a mean opinion score (MOS), a spectrum efficiency parameter, an energy efficiency parameter, a performance parameter, a traffic parameter, an interference parameter, or a prediction parameter.

17. The one or more non-transitory, computer-readable storage media of claim 15, wherein the plurality of spectrum parameters comprise at least one of: availability of spectrum bands, status of cell sites associated with spectrum, or an alarm associated with spectrum.

18. The one or more non-transitory, computer-readable storage media of claim 15, wherein the operations further comprise:
monitoring the QoS metric;
determining that QoS metric satisfies a threshold criterion; and
redetermining the one or more spectrum bands for the first request according to the QoS metric and the plurality of spectrum parameters.

19. The one or more non-transitory, computer-readable storage media of claim 15, wherein the operations further comprise:
monitoring the plurality of spectrum parameters;
determining that at least one spectrum parameter of the plurality of spectrum parameters satisfies a threshold criterion; and
redetermining the one or more spectrum bands for the first request according to the QoS metric and the plurality of spectrum parameters.

20. The one or more non-transitory, computer-readable storage media of claim 15, wherein the operations further comprise:
determining a respective quality of service (QoS) metric associated with each request of the plurality of requests;
determining one or more respective spectrum bands for each request according to the respective QoS metric and the plurality of spectrum parameters; and
allocating the one or more respective spectrum bands responding to each request to a corresponding UE of the one or more UE.
